(19) United States
(12) Patent Application Publication
(10) Pub. No.: US 2003/0196679 A1
(43) Pub. Date: Oct. 23, 2003

(54) Process and apparatus for contacting a precision surface with liquid or supercritical carbon dioxide

(75) Inventors: John Michael Cotte, New Fairfield, CT (US); Emily E. Fisch, Burlington, VT (US); Kenneth John McCullough, Fishkill, NY (US); Wayne Martin Moreau, Wappinger, NY (US); Harald Okorn-Schmidt, Putnam Valley, NY (US); Keith R. Pope, Danbury, CT (US); John P. Simons, Wappingers Falls, NY (US); William A. Syverson, Colchester, VT (US); Charles J. Taft, Wappingers Falls, NY (US)

Correspondence Address: Steven Fischman, Scully, Scott, Murphy & Presser, 400 Garden City Plaza, Garden City, NY, 11530, US

(73) Assignee: INTERNATIONAL BUSINESS MACHINES CORPORATION, Armonk, NY

(21) Appl. No.: 10/124,842

(22) Filed: Apr. 18, 2002

(51) Int. Cl. B08B 3/12

(52) U.S. Cl. 134/1; 134/184

(57) ABSTRACT

A process and apparatus for the processing of a precision surface. The process and apparatus includes contacting of a precision surface in a process chamber with liquid or supercritical carbon dioxide in which sonic waves are generated.

### BACKGROUND OF THE DISCLOSURE

1. Field of the Invention

The present invention is directed to a process and apparatus for contacting a precision surface with liquid or supercritical carbon dioxide. More specifically, the present invention is directed to a process and apparatus for contacting a precision surface with liquid or supercritical carbon dioxide accompanied by sound waves.

2. Background of the Prior Art

The cleaning of precision surfaces semiconductor wafers, masks therefor, pellicles and the like with liquid or supercritical carbon dioxide and other supercritical fluids is known in the art. Liquid or supercritical carbon dioxide has very low surface tension permitting that fluid to penetrate into very small openings. This property distinguishes liquid or supercritical carbon dioxide from other cleaning fluids, primarily aqueous based, which have significantly higher surface tensions. Moreover liquid or supercritical carbon dioxide has no adverse environmental effects when released to the atmosphere. Finally, no residual liquid or supercritical carbon dioxide remains on the precision surface after contact therewith.

Although other supercritical fluids share some of these advantages, liquid or supercritical carbon dioxide is readily available and is significantly cheaper than other supercritical fluids. In addition, liquid or supercritical carbon dioxide is completely nontoxic. As such, the utilization of liquid or supercritical carbon dioxide in the cleaning and processing of precision surfaces has been the subject of many recent developments.

A limitation in the utilization of liquid or supercritical carbon dioxide in the cleaning and contacting of precision surfaces is the apparatus that is utilized in performing this function. Processes for contacting precision surfaces with liquid or supercritical carbon dioxide requires an environment in which the carbon dioxide remains in the liquid or supercritical state. Furthermore, the liquid or supercritical carbon dioxide is often more effectively employed in combination with other materials, i.e. as a composition. Thus, in addition to the requirement that the liquid or supercritical carbon dioxide contact the precision surface to be cleaned, processed and the like, it is also often necessary that the components of the composition, which are combined with liquid or supercritical carbon dioxide, be intimately combined with each other.

A tool known in the art for contacting a precision surface with liquid or supercritical carbon dioxide or composition thereof for cleaning, debris removal and the like of precision surfaces is disclosed in U.S. Pat. No. 5,976,264. That apparatus also permits mixing of liquid or supercritical carbon dioxide with other components of the composition, i.e. a surfactant, a co-solvent and the like. The apparatus of the '264 patent employs an impeller for mixing the liquid or supercritical carbon dioxide composition components during contact with a precision surface. The use of an impeller, propeller or other stirring device, although effective, does not provide advantages which are desirable in the mixing of components of liquid or supercritical carbon dioxide compositions or the employment of liquid or supercritical carbon dioxide alone or in a composition in cleaning and processing of precision surfaces.

As those skilled in the art are aware, the use of a mechanical stirring device is intrusive, adding moving parts and exposing the contacting materials to lubricants and the like required in the operation of such moving parts. Furthermore, stirring devices provide minimal pressure gradients. Pressure gradients, of greater magnitude than that provided by stirring devices, aid in the removal of debris from micron sized openings typical of precision surfaces.

Another limitation of the apparatus of the prior art employed in contacting precision surfaces with liquid or supercritical fluids, such as liquid or supercritical carbon dioxide, is that the duration of contact in removing debris cannot be easily accelerated. Those skilled in the art are aware that the usual method of accelerating cleaning operations is to raise the temperature and/or pressure of the cleaning medium. In the case of liquid or supercritical carbon dioxide, however, such thermodynamic change could disturb the thermodynamic state of the carbon dioxide. Since it is essential that the carbon dioxide remain in the liquid or supercritical fluid state, it is often not possible to alter thermodynamic conditions to accelerate cleaning action. Obviously, other energy altering means, which do not disturb the thermodynamic conditions to which the carbon dioxide is subjected but which accelerate cleaning and other processing purposes of liquid or supercritical carbon dioxide, would be highly desirable.

Recently, attention has focused upon the utilization of sonic attenuation of supercritical fluids in technical articles. For example, Ando et al., J. Org. Chem., 63, 60486049 (1998) and Kohno et al., J. Non Cryst. Solids, 250-252, 139-143, (1999) both relate to the use of sonic energy in combination with a supercritical fluid, albeit not carbon dioxide.

The use of sonic energy, not in combination with a supercritical fluid or a high pressure liquid, in cleaning precision surfaces is known in the art. U.S. Pat. Nos. 4,118,649; 4,326,553; 4,736,759; 4,736,760; 4,804,007; 4,869,278; 4,998,549; 5,037,481; 5,090,432; 5,143,103; 5,148,823; 5,286,657; 5,355,048; and 5,365,960 all discuss cleaning and processing of precision surfaces, such as semiconductor wafers, utilizing megasonic energy.

The above remarks suggest the need in the art for a new process and apparatus for combining the advantages exhibited in the prior art of cleaning and processing precision surfaces utilizing a combination of sonic energy and supercritical fluids.

### BRIEF SUMMARY OF THE INVENTION

A new process and apparatus has now been discovered which combines the advantages of sonic energy and liquid or supercritical carbon dioxide in the processing of precision surfaces.

In accordance with the present invention an apparatus is provided for the processing of a precision surface. The apparatus includes a process chamber in which a precision surface is disposed. The apparatus further includes means for introducing liquid or supercritical carbon dioxide therein. In addition, means for maintaining the processing chamber under thermodynamic conditions consistent with the retention of carbon dioxide in the liquid or supercritical fluid state is provided. A sonic generator for the generation of sonic energy, disposed in conductance communication with the process chamber, is also provided.

In further accordance with the present invention a process is provided for the processing of a precision surface. In this process a precision surface is disposed in a process chamber. Liquid or supercritical carbon dioxide is introduced into the process chamber maintained under thermodynamic conditions consistent with the retention of carbon dioxide in the liquid or supercritical fluid state. Sonic energy, generated in the process chamber, is propagated therein impinging on the precision surface to enhance the processing action of the liquid or supercritical carbon dioxide.

### BRIEF DESCRIPTION OF THE DRAWINGS

The present invention may be better understood by reference to the accompanying drawings of which:

FIG. 1 is a schematic diagram of an apparatus employed in the instant invention for the processing of a precision surface;

FIG. 2 is a schematic representation of an element of the apparatus of FIG. 1; and

FIG. 3 is a schematic representation of an alternative element of the apparatus of FIG. 1.

### DETAILED DESCRIPTION

The apparatus of the present invention includes a process chamber 12 having a sample zone 14 therein for the disposition of a precision surface, denoted by reference numeral 16. The term “precision surface” is used herein to denote a material which contains a surface that has cavities, trenches and/or channels incorporated therein. Suitable precision surfaces that may be employed in the present invention include, but are not limited to, semiconductor samples, metals such as Al, Si, W, Ti, Ta, Pt, Pd, Ir, Cr, Cu and Ag, polymers, such as polyimides, polyamides and the like, and insulators. Of the “precision surfaces” employed in the apparatus and process of the present invention semiconductor samples, e.g. semiconductor wafers, are particularly appropriate for use therein.

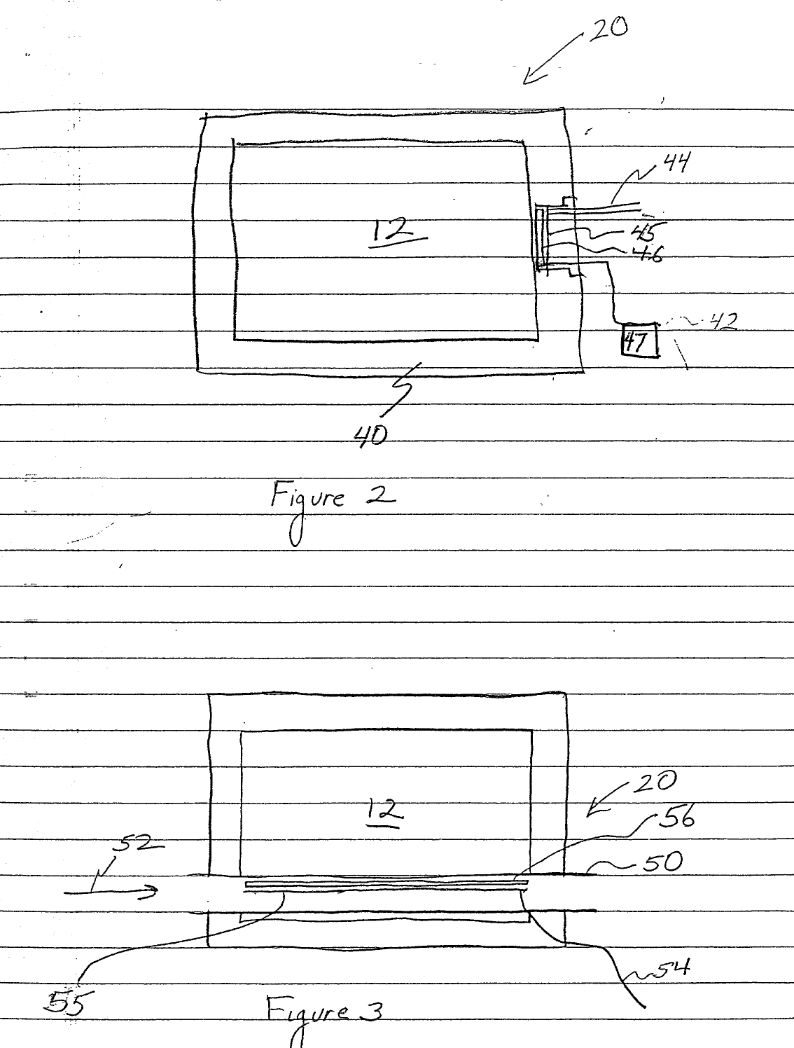

The process chamber 12 is surrounded by a heater jacket 18 and contains sonic generating means 20. Sonic generating means 20 are described in detail in the discussion of FIGS. 2 and 3 below. Additionally, the process chamber includes inlet line 22, outduct 24 and thermocouple 26. The inlet line 22 includes a high pressure pumping system 28 which is connected to a cylinder 30 for supplying liquid or supercritical carbon dioxide to process chamber 12. Cylinder 30 contains pressurized carbon dioxide that enters process chamber 12 as liquid or supercritical carbon dioxide. Thermocouple 26 is connected to heat controller 32 which is utilized for controlling and monitoring the temperature in process chamber 12.

Additional processing equipment that may be provided in the apparatus is depicted in the drawings. Thus, the apparatus may include a reservoir 34 for collecting and/or purifying liquid or supercritical carbon dioxide that exits process chamber 12 through outduct 24. This material may then be recycled into process chamber 12 through duct 35.

It is emphasized that the liquid or supercritical carbon dioxide may be combined with other components to effectuate specific cleaning and processing requirements. Thus, a surfactant may be included with the liquid or supercritical carbon dioxide to enhance penetration into surfaces having very high aspect ratios. Surfactants within the contemplation of the present invention include polyethers, siloxanes, fluoroalkanes, reaction products thereof and mixtures thereof. Although many polyether, siloxane and fluoroalkane surfactants known in the art are useful in the present invention, certain of these surfactants are particularly preferred for utilization in the present invention. For example, amongst polyether surfactants, polyalkylene oxides are preferred. Thus, such polyethers as poly(ethylene oxide) (PEO), poly(propylene oxide) (PPO) and poly(butylene oxide) (PBO) are particularly preferred. Block polymers of these polyalkylene oxides, such as (PPO-bPEO-b-PPO) and (PEO-b-PPO-b-PEO), where b denotes block, i.e. Pluorinic ® triblock copolymers. A polyether surfactant particularly useful in the present invention combines a polyether with a fluorine-containing polymer. That surfactant is perfluoropolyether ammonium carboxylate.

Turning to fluoroalkane surfactants, several fluoroalkanes are useful as the surfactant of the present invention. Among the fluoroalkanes, such species as 4-(perfluoro-2-isopropyl-1,3-dimethyl-1-butenyloxy)benzoic acid (PFBA) and 4-(perfluoro-2-isopropyl-1,3-dimethyl 1-butenyloxy)benzene sulfonic acid (PFBS) find particular application as the surfactant.

Amongst the siloxanes preferred for utilization as a surfactant in the present invention, preference is given to such species as poly(dimethylsiloxane) (PDMS) copolymers. As stated above, combination of these surfactants are particularly preferred. Thus, the combination of a siloxane and a polyether, such as (PDMS) with PEO-PPO, e.g. (PDMS-g-PEO-PPO), where “g” indicates graft, is particularly desirable.

In addition to liquid or supercritical carbon dioxide, with or without a surfactant, a further component, a co-solvent, may be introduced into the process and apparatus of the present invention. The co-solvent is a chemically inert compound which aids in dissolving the surfactant. Preferred co-solvents usefully employed in the present invention include inert hydrocarbons. Thus, such aliphatic hydrocarbons such as cyclohexane and such aromatic hydrocarbons as xylene are particularly preferred co-solvents. Other co-solvents that may be utilized include such polar solvents as methanol, ethanol and the like.

In addition to the aforementioned co-solvents, another class of co-solvents that may be employed in a liquid or supercritical carbon dioxide composition include fluorinated hydrocarbons. Fluorinated hydrocarbons are particularly preferred insofar as they are more miscible in carbon dioxide than are unsubstituted hydrocarbons. Fluorinated hydrocarbons useful in the present invention include compounds having the formula CF₃(CF₂)ₙCH₃, where n is 2 to 6. Of these, perfluorohexane and perfluoroheptane are particularly preferred.

In certain applications the addition of an acid having a pKa of less than about 4 may be utilized. Such applications are particularly preferred in the removal of post polymeric CF₄-type residue which residue has a complex structure having C—F and C═O bonds formed during etching in the presence of a fluorocarbon. Such acids as formic acid, hydrogen fluoride or an acid having the formula CX₃(CX₂)ₙ COOH or CX₃(CX₂)ₙSO₃H, where X is F, Cl, H or mixtures thereof with the proviso that the acid includes at least one fluorine or chlorine atom; and n is 0, 1 or 2 may be utilized in the present invention.

Typically, the cleaning of precision surfaces occur in process chamber 12 at a pressure in the range of between about 800 psi and about 6,000 psi. More preferably, the pressure in the process chamber 12 is in the range of about 2,000 psi to about 5,000 psi. Most preferably, the pressure in processing chamber 12 is in the range of about 3,000 psi. The temperature in processing chamber 12 is maintained in the range of between about 40° C. and about 100° C. More preferably, the temperature in process chamber 12 is in the range of between about 60° C. and about 80° C. Most preferably, the temperature in processing chamber 12 is about 70° C.

The introduction of components, in addition to liquid or supercritical carbon dioxide, i.e. a surfactant, an acid, a co-solvent and the like, may be introduced into process chamber 12 through a reservoir for these material, denoted in the drawings at 36. Reservoir 36 is in flow communication with a conduit 37 which, in turn, is in flow communication with conduit 22. Conduit 22, as indicated earlier, is in flow communication with process chamber 12. Alternatively, the aforementioned components may be pre-introduced into processing chamber 12 prior to introduction of the liquid or supercritical carbon dioxide through conduit 22.

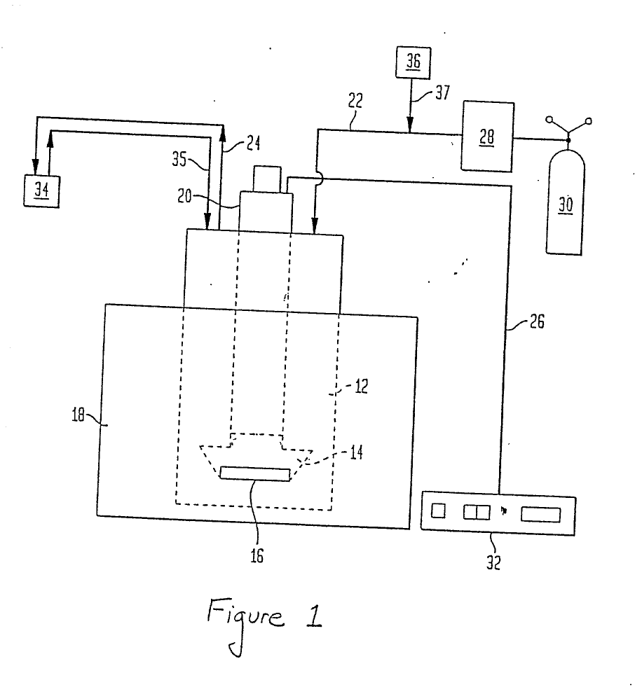

Turning now to a significant advance of the present invention, FIGS. 2 and 3 illustrate preferred embodiments of sonic generating means generally set forth in FIG. 1 at 20. In FIG. 2 sonic generating means 20 are provided in the wall 40 of the process chamber 12. Therein, energy communication means 42 provide electrical power to a sound generating means, a piezoelectric transducer 46 which vibrates at a preset frequency as a function of the power provided to it by energy communication means 42. A power amplifier 47 amplifies the sound waves generated by transducer 46 generating sound waves of the desired frequency into process chamber 12. In this configuration the pressure vessel wall 40 is milled out to allow sonic waves to pass through the reduced thickness. Backing this cavity is an inert gas feed through 44 where the cavity is sealed by plug 45.

Another embodiment of sonic generating means 20 is depicted in FIG. 3. In this embodiment the sonic generating means are disposed in process chamber 12, rather than proximate to it as in the embodiment illustrated in FIG. 2. A conduit 50 is disposed directly in process chamber 12. An inert gas, preferably nitrogen, at a pressure substantially equal to the pressure in process chamber 12, flows in conduit 50, as illustrated by arrow 52. This gas flow is necessary to insure equalization of pressure so that the elevated pressure in process chamber 12 does not crush or distort conduit 50. Power is provided to a sound transducer 55, disposed in conduit 50, by means of electrical conduit 54. The resulting sound waves produced by transducer 55, generating sound waves of the desired frequency, which are amplified by amplifier 56, into process chamber 12.

Independent of the means of providing sonic generating means, the frequency of the sonic waves generated cover a wide range. Preferably, the sonic waves generated cover the frequency in the range of between ultrasonic and megasonic. Thus, the frequency of the sonic waves are preferably in the range of between about 4 kilohertz and 3 megahertz.

The above embodiments are given to illustrate the scope and spirit of the present invention. These embodiments will suggest, to those skilled in the art, other embodiments and examples. These other embodiments and examples are within the contemplation of the present invention. Thus, the present invention should be limited only by the appended claims.

What is claimed is:

1. An apparatus for the processing of a precision surface comprising a process chamber in which a substrate having a precision surface is disposed; means for introducing liquid or supercritical carbon dioxide into said process chamber; means for maintaining said process chamber under thermodynamic conditions consistent with the retention of said carbon dioxide in said liquid or supercritical state; and sonic generating means disposed in or adjacent said process chamber for generation of sonic energy in said process chamber.

2. An apparatus in accordance with claim 1 wherein said sonic generating means comprises a sonic transducer in communication with an energy source and a sonic amplifier in conductance communication with said sonic transducer for generation of amplified sonic waves in said process chamber.

3. An apparatus in accordance with claim 2 wherein said amplified sound waves have a frequency in the range of between about 4 kilohertz and about 3 megahertz.

4. An apparatus in accordance with claim 1 comprising means for introducing components into said process chamber in addition to said liquid or supercritical carbon dioxide wherein a liquid or supercritical carbon dioxide composition is formed.

5. An apparatus in accordance with claim 1 wherein said process chamber is maintained at a pressure in the range of between about 800 psi and about 6,000 psi and a temperature in the range of between about 40° C. and about 100° C.

6. An apparatus in accordance with claim 5 wherein said process chamber is maintained at a pressure in the range of between about 2,000 psi and about 5,000 psi and at a temperature in the range of between about 60° C. and about 80° C.

7. An apparatus in accordance with claim 2 wherein said sonic transducer and said sonic amplifier are disposed in a wall defining said process chamber.

8. An apparatus in accordance with claim 2 wherein said sonic transducer and said sonic amplifier are disposed in a tube situated in said process chamber.

9. An apparatus in accordance with claim 8 wherein an inert gas flows in said tube at a pressure substantially the same as the pressure of said process chamber.

10. A process for processing of a precision surface comprising disposing a precision surface in a process chamber; introducing liquid or supercritical carbon dioxide into said process chamber; maintaining said process chamber under thermodynamic conditions consistent with the maintenance of said carbon dioxide in the liquid or supercritical fluid state; and generating sound waves in said process chamber.

11. A process in accordance with claim 10 wherein said generation of sound waves includes applying an energy source which is converted to sound waves which are thereupon amplified.

12. A process in accordance with claim 11 wherein said amplified sound waves have a frequency in the range of between about 4 kilohertz and about 3 megahertz.

13. A process in accordance with claim 10 comprising introducing components into said process chamber in addition to liquid or supercritical carbon dioxide wherein a liquid or supercritical carbon dioxide composition is formed.

14. A process in accordance with claim 10 wherein said process chamber is maintained at a pressure in the range of between about 800 psi and about 6,000 psi and at a temperature in the range of between about 40° C. and about 100° C.

15. A process in accordance with claim 14 wherein said process chamber is maintained at a pressure in the range of between about 2,000 psi and about 5,000 psi and at a temperature in the range of between about 60° C. and about 80° C.

16. A process in accordance with claim 11 wherein said sound waves are generated from sound generation means disposed in a wall of said process chamber.

17. A process in accordance with claim 11 wherein said sound waves are generated from a tube disposed in said process chamber.

18. A process in accordance with claim 17 wherein said pressure in said tube is maintained substantially the same as said pressure in said process chamber.

19. A process in accordance with claim 18 wherein said pressure in said tube is maintained by means of an inert gas flowing in a tube at a pressure substantially the same as said pressure in said process chamber.
